(19) United States
(12) Patent Application Publication
(10) Pub. No.: US 2003/0177984 A1
(43) Pub. Date: Sep. 25, 2003

(54) Animal vest

(76) Inventor: Earl R. Newman, Washington, DC (US)

Correspondence Address: OLIFF & BERRIDGE, PLC, P.O. BOX 19928, ALEXANDRIA, VA, 22320, US

(21) Appl. No.: 10/392,825

(22) Filed: Mar. 21, 2003

Related U.S. Application Data
(60) Provisional application No. 60/365,801, filed on Mar. 21, 2002.

(51) Int. Cl. A01K 13/00

(52) U.S. Cl. 119/850

(57) ABSTRACT

A vest, preferably made of breathable polymeric material, is securable to an animal such as a dog. Weight devices, such as elongate weight devices extending in a chest-circumferential direction of the animal, may be attached to the vest. The weight devices preferably are detachable from the vest. In place of or in addition to the weight devices, buoyancy enhancing devices and/or visibility enhancing devices, may be attachable to the vest in place of the elongate weight devices.

This non-provisional application claims the benefit of U.S. Provisional Patent Application 60/365,801 filed Mar. 21, 2002, which is incorporated herein by reference in its entirety.

### BACKGROUND OF THE INVENTION

1. Field of Invention

This invention relates to apparatus for animal training and/or animal safety.

2. Description of Related Art

“Working class” dogs are used in a variety of fields, such as law enforcement, search and rescue, hunting, and competitions such as dog shows, dog racing or weight pulling, and the like.

Traditionally, however, many people have failed to recognize these animals as professionals and athletes. Consequently, unlike human professionals and athletes, dogs are often not given proper or adequate physical training.

For example, dogs often accompany police officers during investigations, but all too often the dogs' human counterparts take the dogs' abilities for granted. Sadly, instances have occurred in which an inadequately trained police dog was injured by another dog, or by a human assailant, particularly a human assailant whose behavior and perceptions have been altered by, for example, illegal drugs or alcohol.

Fortunately, some are now beginning to recognize the need for more conscientious and effective physical training of animals, particularly working class animals.

U.S. Pat. No. 5,769,030 to Acoff discloses an animal training and conditioning apparatus. As shown in the drawings of this patent, the apparatus includes weighted back and chest straps 20, 22, respectively, which are secured to the neck of a dog by a collar 14 and about the torso of a dog by a lower portion 30 and a mating upper portion 28.

### SUMMARY OF THE INVENTION

A disadvantage of the apparatus disclosed in U.S. Pat. No. 5,769,030 is that, if the upper portion 28 and lower portion 30 rotate around the torso of the dog during use, the weight in the back strap 20 and chest strap 22 may become unbalanced. Another disadvantage is that the weights in the back strap 20 and chest strap 22 appear to be sewn in, and thus not easily removable or replaceable to adjust the amount of weight therein. Additionally, the apparatus allows for relatively concentrated weighting of the torso region of the dog, which may have the undesirable effect of contributing to hip dysplasia.

The present invention can ameliorate one or more of these disadvantages, although in embodiments of the invention, one or more of these disadvantages may be present in some degree, and such embodiments are not disclaimed from the scope of the invention.

An object of this invention can be to provide a weighted apparatus that can be used to efficiently train, e.g., with anaerobic, aerobic and/or cardiovascular training, an animal, particularly a four-legged animal such as a dog.

Another object of the invention can be to enable one or more additional uses of an apparatus in addition to weight training or conditioning. For example, in addition to being used as a weight training apparatus, embodiments of the invention may also be used for increasing animal buoyancy, e.g., in water environments, and/or for increasing animal visibility, e.g., in nocturnal environments.

Accordingly, in embodiments, the invention can provide a weightable apparatus, including a vest that is securable to an animal; and at least one elongate weight device attached to the vest. The at least one elongate weight device may extend in a chest-circumferential direction of the animal and/or a neck-circumferential direction of the animal. The vest may include a chest encircling portion and a neck encircling portion, which may be connected by a connection portion, and the chest encircling portion, the neck encircling portion and the connection portion may be formed together as one piece. The at least one elongate weight device may be detachable from the vest, and buoyancy enhancing devices and/or visibility enhancing devices may be attachable to the vest in place of the weight devices.

In another aspect, the invention can provide a system that provides, selectively or simultaneously, at least two of: a weight device that adds weight to an animal for training; a buoyancy enhancing device that enhances buoyancy of the animal; and a visibility enhancing device that enhances visibility of the animal. The weight device may include one or more flexible elongate weight devices that are releasably attached to a vest. The buoyancy enhancing device may include one or more elongate buoyancy enhancing devices that are releasably attached to a vest. The visibility enhancing device may include one or more visibility enhancing devices that are attached to a vest, either permanently, semi-permanently or detachably.

In yet another aspect, the invention can provide an apparatus, including a vest of breathable polymeric material that is securable to an animal, and at least one of: a weight device that is attachable to the vest; and a buoyancy enhancing device that is attachable to the vest. The weight device may include one or more flexible elongate weight devices that are releasably attached to the vest, and the buoyancy enhancing device may include one or more elongate buoyancy enhancing devices that are releasably attached to the vest. The elongate weight devices may include flexible tubular bodies filled with a particulate or fluid material.

These and other objects, advantages and salient features of the invention are described in or apparent from the following detailed description of exemplary embodiments.

### BRIEF DESCRIPTION OF THE DRAWINGS

Exemplary embodiments of the invention will be described with reference to the accompanying drawings, wherein like numerals represent like parts, and wherein:

FIG. 1 is a perspective view of an exemplary apparatus according to the invention in a flat state;

FIG. 2 is a perspective blow-apart view of the apparatus shown in FIG. 1;

FIG. 3 is a top plan view of the apparatus shown in FIG. 1;

FIG. 4 is a bottom plan view of the apparatus shown in FIG. 1;

FIG. 5 is a front view of the apparatus shown in FIG. 1;

FIG. 6 is a rear view of the apparatus shown in FIG. 1;

FIG. 7 is a right side view of the apparatus shown in FIG. 1;

FIG. 8 is a left side view of the apparatus shown in FIG. 1;

FIG. 9 illustrates exemplary details of attachment of the apparatus shown in FIG. 1 to an animal;

FIG. 10 illustrates the apparatus of FIG. 1 secured to an animal;

FIG. 11 illustrates the apparatus of FIG. 1 removed from an animal, and with weight devices removed from the apparatus;

FIG. 12 illustrates a buoyancy enhancing apparatus secured to an animal; and

FIG. 13 illustrates a visibility enhancing apparatus secured to an animal.

### DETAILED DESCRIPTION OF PREFERRED EMBODIMENTS

This invention can provide an apparatus that distributes weight on an animal in a manner that is safe for the animal, and in a manner that is very effective for anaerobic, aerobic and/or cardiovascular training of the animal. The invention can also provide an apparatus that enhances buoyancy of an animal. The invention can also provide visibility enhancement for an animal. The invention can also provide, selectively or simultaneously, a combination of two or more of a weight adding function, a buoyancy enhancing function, and a visibility enhancing function.

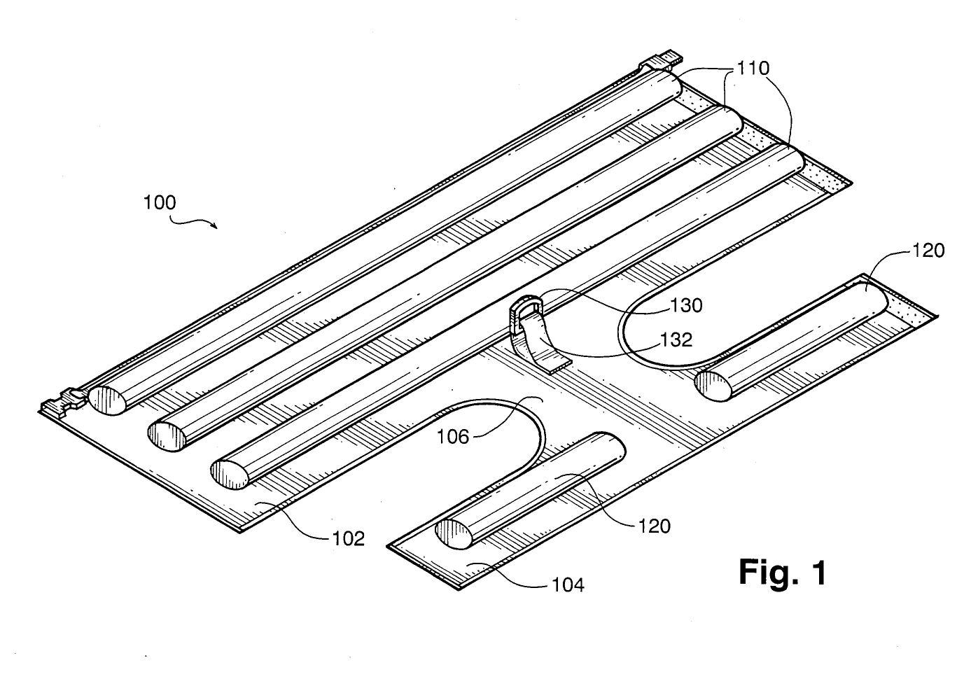

FIG. 1 is a perspective view of an exemplary apparatus 100 according to the invention. In this example, the apparatus 100 is in the form of a vest that includes a chest encircling portion 102 and a neck encircling portion 104, which are connected by a connection portion 106. The chest encircling portion 102, the neck encircling portion 104 and the connection portion 106 are shown as being formed as one piece, but this does not limit the invention. Those skilled in the art will appreciate that the chest encircling portion 102, the neck encircling portion 104 and/or the connection portion 106 can be formed as separate pieces and then connected together. Those skilled in the art will also appreciate that the length of the connection portion may, if desired, be made adjustable to enable variation of the length between the chest encircling portion 102 and the neck encircling portion 104. However, forming the chest encircling portion 102, the neck encircling portion 104 and the connection portion 106 as a single piece is advantageous in terms of ease of manufacture and resistance to relative twisting or rotation between the chest encircling portion 102 and the neck encircling portion 104.

The chest encircling portion 102, the neck encircling portion 104 and the connection portion 106 are preferably made of a breathable sheet material, although the invention is not limited to breathable materials. Acceptable materials include cloth, such as denim or other types of woven or non-woven textiles or the like, and leather. Polymeric materials such as neoprene rubber may also be used, and a particularly preferred polymeric material is breathable neoprene, such as BREATH-O-PRENE®, manufactured by AccuMED Technologies Inc. of Buffalo, N.Y., or FLOPRENE®, manufactured by ProLine Manufacturing.

A cushion and/or wicking layer (not shown) is preferably attached to the layer of breathable polymeric material or sheet material to enhance the animal's comfort when wearing the apparatus. While dogs do not perspire as humans do, a dog's skin nonetheless “breathes,” and using a breathable material for the apparatus, optionally in conjunction with a wicking material, permits such “breathing” to occur relatively unimpeded.

A breathable polymeric material such as BREATH-O-PRENE® or FLOPRENE® also creates a thermal barrier between the animal's body and the atmosphere. This may be advantageous when exercising the animal in chilly weather, and/or when the animal is in a water environment.

As shown in FIG. 1, weight devices such as elongate weights 110 may be attached to the chest encircling portion 102, and weight devices such as elongate weights 120 may be attached to the neck encircling portion 104. The elongate weights may be attached permanently, but preferably are removably attached, as described in more detail below.

As used herein, “weights” or “weight devices” refers to devices that significantly add to the weight of the overall apparatus, e.g., that, alone and/or in combination, increase the weight of the apparatus by 100% or more, and preferably by 200%, 300%, 400%, 500% or more. Additionally, as used herein, “elongate” means having a length-to-width ratio or length-to-diameter ratio of at least 2:1, preferably at least 3:1, such as 4:1 or greater, 5:1 or greater, 6:1 or greater, 7:1 or greater, 8:1 or greater, 9:1 or greater, or 10:1 or greater.

The apparatus 100 may include an attachment ring 130, to which a leash or other device may be attached. The ring 130 may be connected to, for example, the connection portion 106 of the apparatus 100 via an attachment piece 132.

The elongate weights 110 and 120 are preferably hollow tubes, such as vinyl or plastic tubes, that may be filled with material such as sand or other granular material, or liquid material. The tubes may be permanently sealed after being filled with weighting material, or may be openable and closable so that a user, may, as desired, empty, fill, or partially fill the tubes.

When fully loaded with weights 110 and 120, the apparatus 100 may, for example, weigh from about 3 lbs. to about 10 lbs., preferably from about 4 lbs to about 8 lbs., for small dogs; from about 5 lbs. to about 15 lbs., preferably from about 5 lbs. to about 12 lbs., for medium-size dogs; and from about 5 lbs. to about 25 lbs., preferably from about 5 lbs. to about 20 lbs., for large dogs. In contrast, the weight of the unloaded apparatus 100 may be from about 0.5 lbs. to about 2 lbs. Other weights may be selected as appropriate or desired depending, for example, on the particular intended application (e.g., on whether the intended application is heavy strength training, light conditioning, or something in-between), and/or on the particular animal on which the apparatus 100 is to be used.

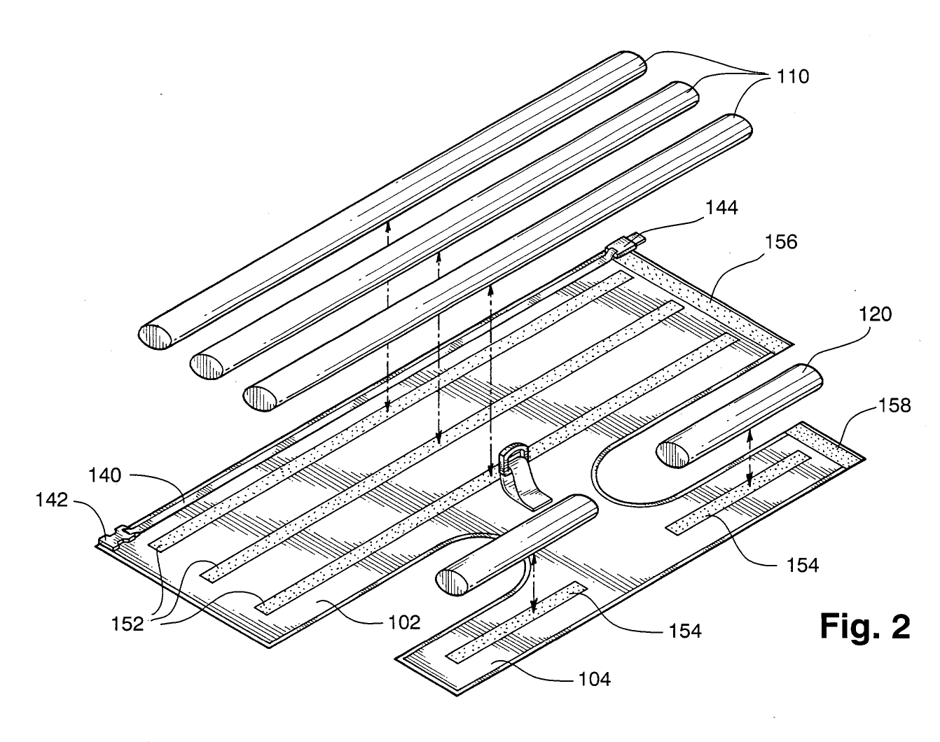

FIG. 2 is a perspective blow-apart view of the apparatus 100, with the elongate weights 110 and 120 removed. Attachment devices 152 attach the elongate weights 110 to the chest encircling portion 102, and attachment devices 154 attach the elongate weights 120 to the neck encircling portion 104.

The attachment devices 152 and 154 may be permanent or semi-permanent attachment devices, such as adhesive strips or the like, but preferably are selectively releasable attachment devices, i.e., devices that permit easy detachment and re-attachment by a user. For example, the attachment devices 152 and 154 may be the “loop” part of a hook and loop type fastener, such as VELCRO™, and the “hook” portion of the hook and loop fastener may be provided on the bottom side of elongate weights 110 and 120, respectively, or vice versa.

As another example, instead of a hook and loop fastener, an interlockable fastener such as 3M™ Dual Lock™ fastener may be used as the attachment devices 152 and 154. In an interlockable fastener, there are not “hooks” and “loops;” rather each part of the fastener has headed members that protrude therefrom, and the headed members of one fastener part interlock with the headed members of the other fastener part. For example, the attachment devices 152 and 154 may each be a strip of interlockable fastener, and a corresponding strip of interlockable fastener may be provided on the bottom of each elongate weight 110 or 120.

As another example, a combination of hook and loop fastener and interlockable fastener may be used as the attachment devices 152 and 154. A particularly effective combination is the “loop” part of a hook and loop fastener used in conjunction with a strip of interlockable fastener material, e.g., the “soft” side of VELCRO™ used in conjunction with a strip of 3M™ Dual Lock™ fastener. For example, the fastening devices 152 and 154 may be the “loop” side of the hook and loop side fastener, and a strip of interlockable fastener may be provided on the bottom of each elongate weight 110 or 120, or vice versa. Using such a combination has been found to be more effective than using a hook and loop fastener alone, or an interlockable fastener alone.

As yet other examples, snaps, zippers or the like may be used as the attachment devices 152 and 154.

A torso-securing belt 140 may be attached at, for example, a rear end of the check encircling portion 102, and, when the apparatus 100 is placed on an animal, the torso-securing belt 140 may be connected together at its ends by matable devices 142 and 144. The torso-securing belt 140 may be adjustable.

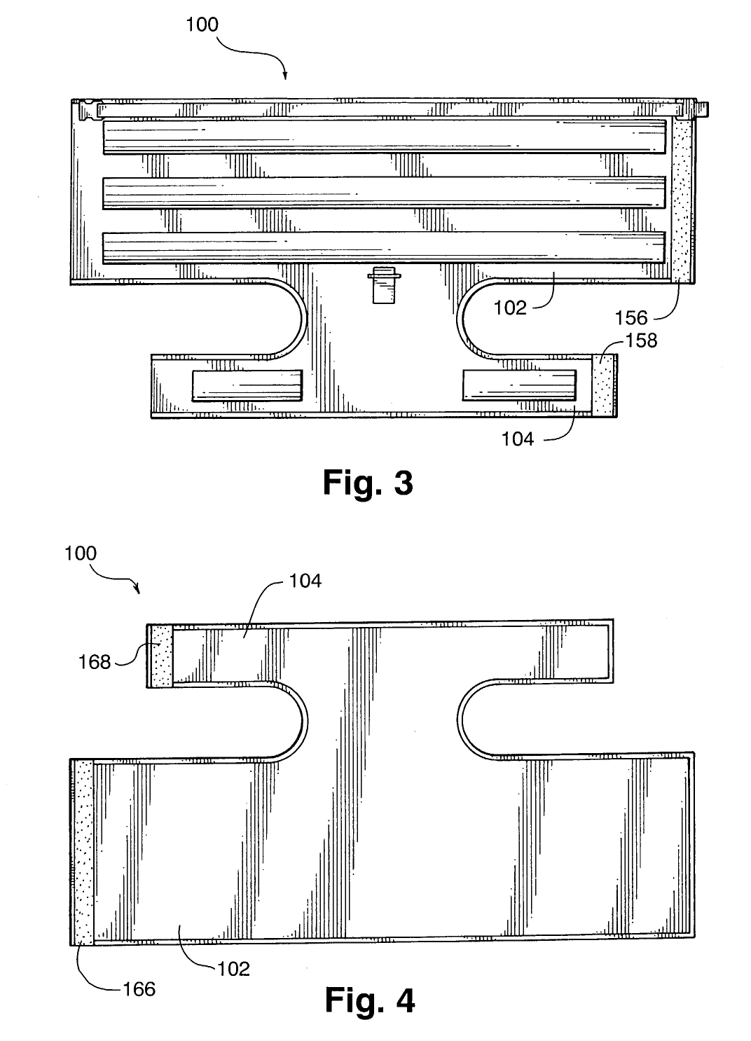

FIG. 3 is a top plan view of the apparatus 100, and FIG. 4 is a bottom plan view of the apparatus 100. As shown in FIG. 3, an attachment device 156 is provided at one side of the chest encircling portion 102, and an attachment device 158 is provided at one side of the neck encircling portion 104. As shown in FIG. 4, an attachment device 166 is provided at a side of the chest encircling portion 102 on an inner surface of the apparatus 100, and an attachment device 168 is provided at a side of the neck encircling portion 104. The attachment devices 166 and 168 are provided at opposite sides of the apparatus 100 with respect to the attachment devices 156 and 158 such that, when the apparatus 100 is placed on an animal, the attachment device 156 can attach to the attachment device 166, and the attaching device 158 can attach to the attachment device 168. The attachment devices 156, 158, 166 and 168 are preferably hook and loop fasteners. For example, elements 156 and 158 may be the “hook” portion of the hook and loop fastener, and attachment devices 166 and 168 may be the “loop” portion of the hook and loop fastener. Other fasteners such as snaps, zippers, snap-lock devices with matable members, or the like are also acceptable.

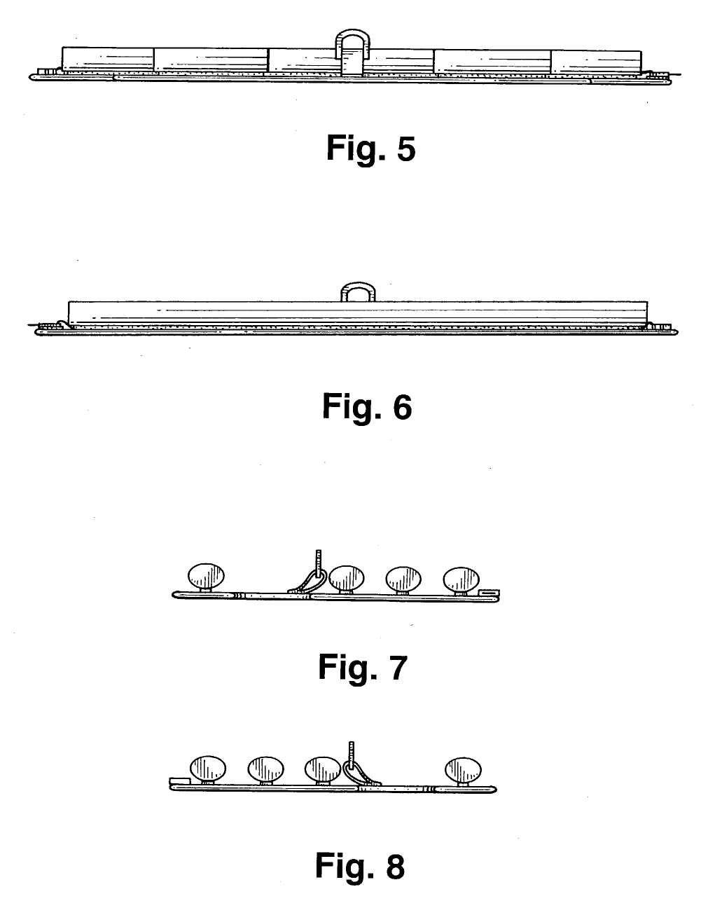

FIGS. 5-8 show, respectively, a front view of the apparatus 100, a rear view of the apparatus 100, a right side view of the apparatus 100, and a left side view of the apparatus 100.

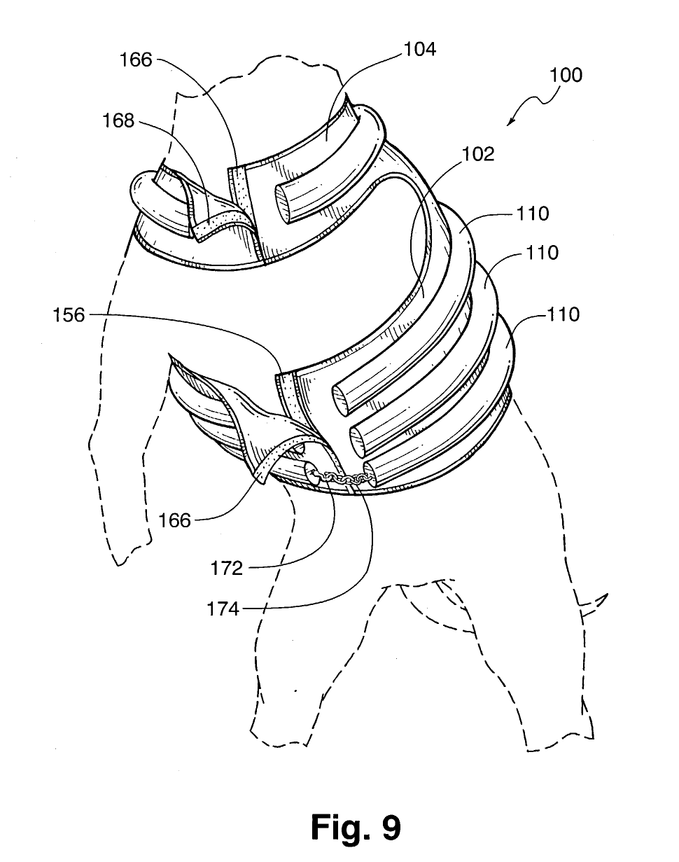

FIG. 9 shows the apparatus 100 being attached to an animal. As depicted, the chest encircling portion 102 is wrapped around the chest of an animal, and the neck encircling portion 104 is wrapped around the neck of an animal. Thus, the elongate weights 110 extend in a chest-circumferential direction, and the elongate weights 120 extend in a neck-circumferential direction.

As depicted, the attachment device 156 engages with the attachment device 166 to secure the chest encircling portion 102 about the animal's chest, and the attachment device 166 engages with the attachment device 168 to secure the neck encircling portion 104 about the neck of the animal. Additionally, as depicted, ends of the elongate weights 110 may be connected to each other by connectable devices 172 and 174, such as hooks and chains or the like. The connectable devices 172 and 174 can provide additional protection, beyond that provided by the attachment devices 152 shown in FIG. 2, against accidental removal or detachment of the elongate weights 110 from the apparatus 100. Although connectable devices 172 and 174 are only shown on one of the elongate weights 110, it should be appreciated that connectable devices 172 and 174 may also be provided on one or more other ones of the elongate weights 110, and/or on the elongate weights 120.

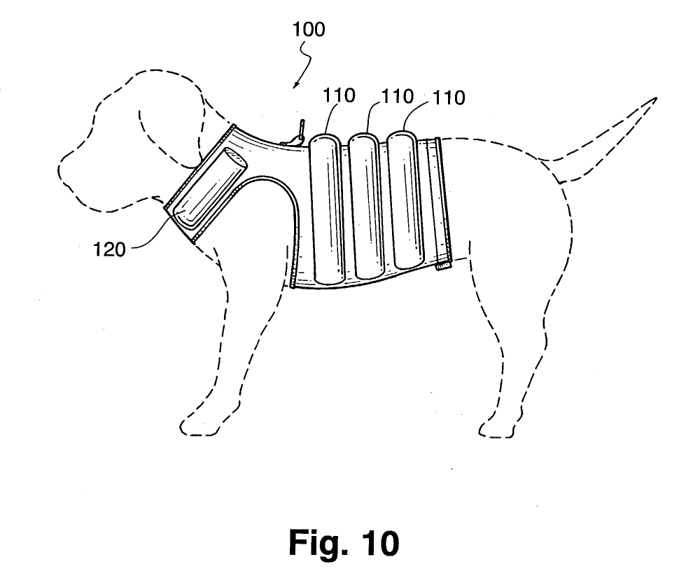

FIG. 10 shows the apparatus 100 secured to an animal. It can be appreciated from FIG. 10 that the elongate weights 110 and 120 provide an even distribution of weight over the apparatus 100, which is more comfortable to the animal than localized or concentrated “heavy points.” It can also be appreciated that the majority of the weight of the apparatus 100 is borne by the front legs and shoulders of the animal, which reduces the risk of hip dysplasia.

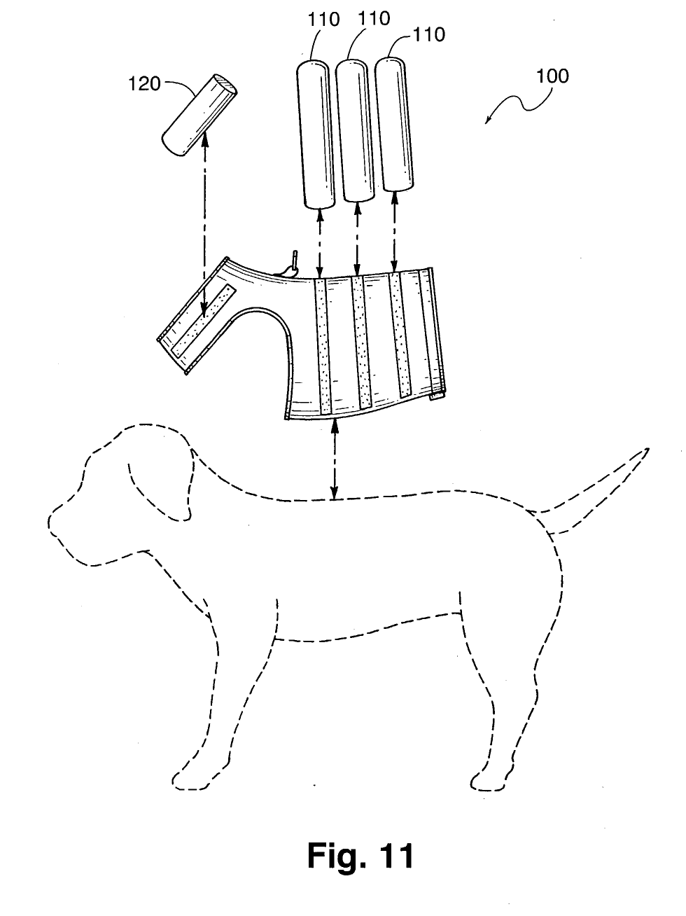

FIG. 11 shows the elongate weights 110 and 120 removed from the apparatus 100. The elongate weights 110 and 120 may be removed from the apparatus 100 while the apparatus 100 is on the animal, or while the apparatus 100 is not on the animal.

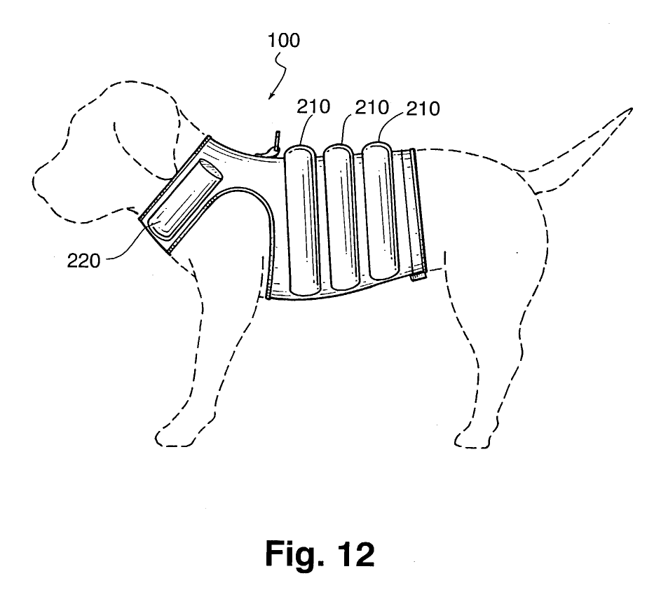

In FIG. 12, instead of elongate weights 110 and 120, elongate buoyancy enhancing devices 210 and 220 are attached to the apparatus 100. The buoyancy enhancing devices 210 and 220 may be attached to the apparatus 100 in the same manner as the elongate weights 110 and 120, e.g., by attachment devices such as hook and loop fasteners and/or interlocking fasteners. The elongate buoyancy enhancing devices 210 and 220 may be, for example, of foamed material, hollow tubing, or the like.

When the apparatus 100 is to be used as a buoyancy enhancing apparatus, the size and/or number of the buoyancy enhancing elements 210 and/or 220 may be selected to provide a desired degree of buoyancy. In some applications, the animal owner may desire to provide complete flotation capability, i.e., a degree of buoyancy such that, even if the animal stops swimming, it would not sink. In other applications, the animal owner may desire to provide only a small degree of buoyancy to merely assist the animal, without providing complete flotation capability.

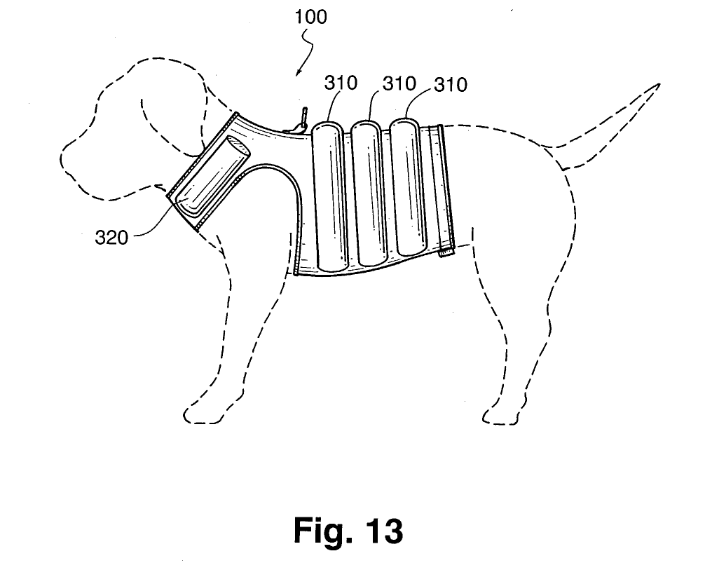

In FIG. 13, in place of the elongate weights 110 and 120 or the buoyancy enhancing devices 210 and 220, visibility enhancing devices 310 and 320 are attached to the apparatus 100. Like the buoyancy enhancing devices 210 and 220, the visibility enhancing devices 310 and 320 may be attached to the apparatus 100 in the same manner as the elongate weights 110 and 120, by attachment devices 156. The visibility enhancing devices 310 and 320 may, for example, be strips of white or other light-colored and/or reflective material.

It should be appreciated that visibility enhancement devices 310 and/or 320 may be provided in addition to, rather than in place of, the elongate weights 110 and 120 or the buoyancy enhancing devices 210 and 220. For example, visibility strips may be provided between the elongate weights 110 and/or 120, either permanently or by separate attachment devices. Alternatively, for example, one or more, but not all, of the elongate weights 110 and 120 may be replaced by a visibility enhancing device 310 or 320, or one or more, but not all, of the buoyancy enhancing devices 210 and 220 may be replaced by a visibility enhancing device 310 or 320.

Another alternative for providing visibility enhancement is to make the elongate weights 110 and/or 120, or the buoyancy enhancing devices 210 and 220, out of material with good visibility, or to apply thereto a layer of good-visibility material, such as light-colored and/or reflective paint, tape, cloth or the like.

While the invention has been described in conjunction with specific embodiments described above, equivalent alternatives, modifications and variations will become apparent to those skilled in the art when given this disclosure. Accordingly, the preferred embodiments of the invention as set forth above are considered to be illustrative and not limiting. Various changes to the described embodiments may be made without departing from the spirit and scope of the invention.

What is claimed is:

1. A weightable apparatus, comprising:
a vest that is securable to an animal; and
at least one elongate weight device attached to the vest.

2. The weightable apparatus of claim 1, wherein the at least one elongate weight device extends in a chest-circumferential direction of the animal.

3. The weightable apparatus of claim 1, wherein the vest comprises a chest encircling portion and a neck encircling portion.

4. The weightable apparatus of claim 3, wherein the chest encircling portion and the neck encircling portion are connected by a connection portion, and the chest encircling portion, the neck encircling portion and the connection portion are formed together as one piece.

5. The weightable apparatus of claim 3, wherein the at least one elongate weight device comprises at least one first elongate weight device attached to the chest encircling portion and at least one second elongate weight device attached to the neck encircling portion.

6. The weightable apparatus of claim 1, wherein the at least one elongate weight device is detachable from the vest.

7. The weightable apparatus of claim 6, further comprising at least one of (a) one or more elongate buoyancy enhancing devices and (b) one or more visibility enhancing devices, that are attachable to the vest in place of the elongate weight devices.

8. The weightable apparatus of claim 1, wherein a material of the vest comprises breathable polymeric material.

9. The weightable apparatus of claim 1, wherein the at least one elongate weight device comprises a tubular body filled with a particulate or fluid material.

10. The weightable apparatus of claim 1, wherein the at least one elongate weight device is flexible.

11. A system that provides, selectively or simultaneously, at least two of:
a weight device that adds weight to an animal for training;
a buoyancy enhancing device that enhances buoyancy of the animal; and
a visibility enhancing device that enhances visibility of the animal.

12. The system of claim 11, wherein the weight device comprises one or more flexible elongate weight devices that are releasably attached to a vest.

13. The system of claim 11, wherein the buoyancy enhancing device is provided by one or more elongate buoyancy enhancing devices that are releasably attached to a vest.

14. The system of claim 11, wherein the visibility enhancing device is provided by one or more visibility enhancing devices that are attached to a vest.

15. The system of claim 14, wherein the one or more visibility enhancing devices are selectively detachable from the vest.

16. An apparatus, comprising:
a vest of breathable polymeric material that is securable to an animal; and
at least one of:
a weight device that is attachable to the vest; and
a buoyancy enhancing device that is attachable to the vest.

17. The apparatus of claim 16, wherein the weight device comprises one or more flexible elongate weight devices that are releasably attached to the vest.

18. The apparatus of claim 16, wherein the buoyancy enhancing device is provided by one or more elongate buoyancy enhancing devices that are releasably attached to a vest.

19. The apparatus of claim 16, wherein the at least one elongate weight device comprises a tubular body filled with a particulate or fluid material.

20. The apparatus of claim 16, wherein the at least one elongate weight device is flexible.
